(19) United States
(12) Patent Application Publication
(10) Pub. No.: US 2012/0278125 A1
(43) Pub. Date: Nov. 1, 2012

(54) METHOD AND SYSTEM FOR ASSESSING PROCESS MANAGEMENT TOOLS

(75) Inventors: Priyanka G. Sriraghavan, Tamil Nadu (IN); Lakshmi Nrusimhan N.V., Tamil Nadu (IN)

(73) Assignee: VERIZON PATENT AND LICENSING INC., Basking Ridge, NJ (US)

(21) Appl. No.: 13/097,525

(22) Filed: Apr. 29, 2011

(51) Int. Cl. G06Q 10/00

(52) U.S. Cl. 705/7.27

(57) ABSTRACT

An approach is provided for performing programmatic assessment of process management applications. A representative process of a workflow is selected. The representative process is executed on a source business process management platform and a target business process management platform. A first set of one or more metric values is captured from the source platform in the execution of the representative process. A second set of one or more metric values is captured from the target platform in the execution of the representative process. An assessment score is generated based on the first set of metric values and the second set of metric values. A determination is made whether to migrate from the source platform to the target platform based on the assessment score.

### BACKGROUND INFORMATION

Large organizations, e.g., business enterprises, routinely develop and refine processes in the conduct of their business objectives. Because of the intricacies of some of these processes, any change or redevelopment of such processes can result in significant delays and inefficiencies. Consequently, products, such as workflow software and business process management (BPM) tools, have emerged to facilitate the development and implementation of business processes. Unfortunately, these products lack standardization, and thus, adoption of one tool can involve a substantial commitment in that changing to another tool can be cost prohibitive. Because of the difference in functions between BPM tools and the uniqueness of every organization, predicting how any BPM tools may operate within an organization is difficult. That is, any performance enhancements stemming from the migration from an existing platform to another platform are largely unknown. This deterrence may force an organization to compromise by operating suboptimally, even though a new tool may be potentially more effective.

Accordingly, there is a need for a mechanism for assessing performance of different process management tools.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A and 1B are, respectively, a diagram of a system capable of providing programmatic assessment and a flowchart of a process for performing the assessment, according to various embodiments;

FIG. 2 is a diagram of a use case involving a systems manager supporting provisioning of telecommunication services, according to one embodiment;

FIG. 3 is a diagram of an assessment platform capable of evaluating business process management platforms (BPMs), according to an exemplary embodiment;

FIG. 4 is a flowchart of a process for assessing a business process management platform (BPM), according to an exemplary embodiment;

FIG. 5 is a diagram of a process executing module utilized in the system of FIG. 3, according to an exemplary embodiment;

FIG. 6 is a diagram of a process managing module utilized in the system of FIG. 3, according to an exemplary embodiment;

FIG. 7 is a flowchart of a conversion process involving the mapping of task executors, according to an exemplary embodiment;

FIG. 8 is a flowchart of a process for mapping tools, according to an exemplary embodiment;

FIGS. 9 and 10 are diagrams of graphical user interfaces to map a representative process of a workflow from a target BPM platform's software code to a source BPM platform's software code, according to one embodiment;

FIG. 11 is a flowchart of a conversion process, according to an exemplary embodiment;

FIG. 12 is a diagram of an assessing module, according to an exemplary embodiment;

FIG. 13 is a flowchart of an assessing process involving the changing of metrics, according to an exemplary embodiment;

FIG. 14 is a diagram of a computer system that can be used to implement various exemplary embodiments; and

FIG. 15 is a diagram of a chip set that can be used to implement various exemplary embodiments.

### DESCRIPTION OF THE PREFERRED EMBODIMENT

A preferred apparatus, method, and software for providing an assessment of process management tools are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to products for business processes, it is contemplated that various exemplary embodiments are also applicable to other services.

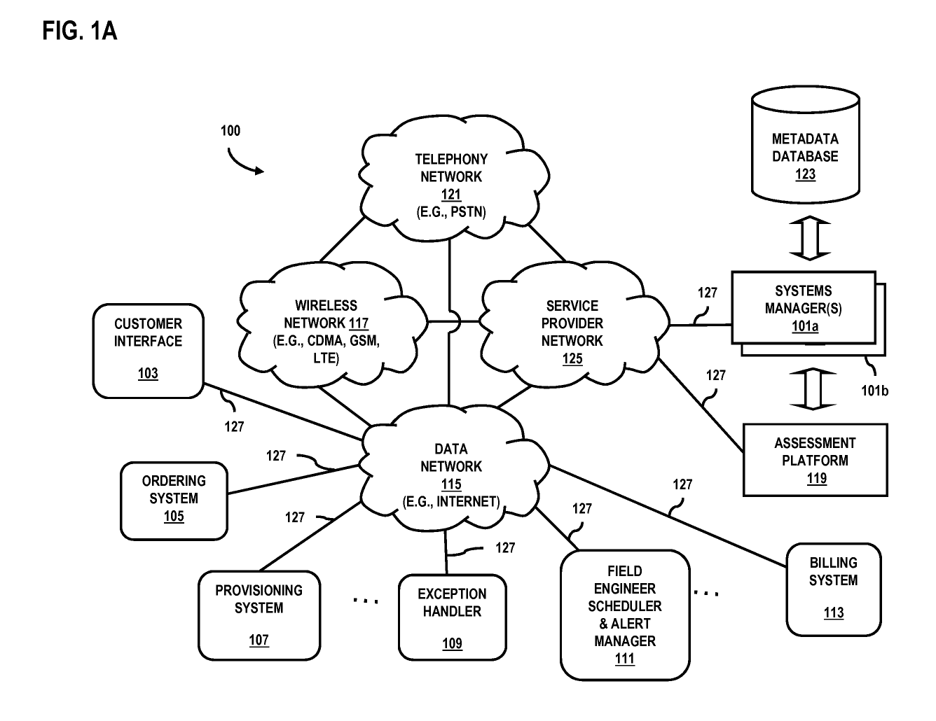

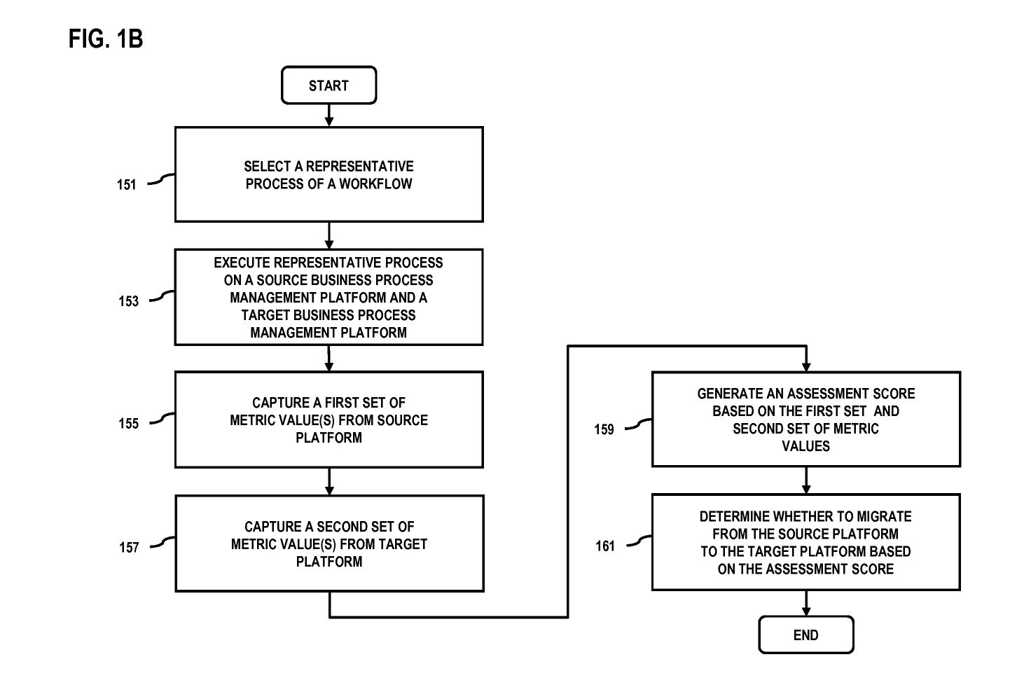

FIG. 1A is a diagram of a system capable of providing programmatic assessment, according to an exemplary embodiment. For the purposes of illustration, system 100 is described with respect to a mechanism for specifically providing an assessment of process management tools (e.g., business process management (BPM) tools) in which services are managed from multiple sources. In this example, systems managers 101a, 101b can execute the business process management tools or applications, and thus, can be referred to as business process management platforms. Although shown as separate components, systems managers 101a, 101b can be the same hardware platform, whereby migration from one system to another system entails software and/or firmware modifications.

For purposes of explanation, a typical organization provide many distinct functions—e.g., manufacturing, legal, accounting, distribution, human resources, etc. Further, this organization utilizes a business process management tool to manage these functions. In this example, the organization seeks to migrate from its current BPM to a different (e.g., competing) BPM. Before investing in the costly migration, an evaluation of the performance is required. To migrate all the processes from the former BPM to the competing BPM may be prohibitive. As such, in accordance with one embodiment, assessment platform 119 selects a representative process to convert. In particular, a single process may be executed in both the current BPM and the competing BPM. Metrics of the execution of the process may be analyzed such that the relative performance of the current BPM and the competing BPM are determined. Non-limiting examples of analyzed metrics may include execution time, processing power, memory allocation and memory access time. Under this arrangement, the target BPM may be considered without providing a costly, total migration to the target BPM.

As shown, systems manager 101 has connectivity to one or more operational systems in support of telecommunication services—e.g., a customer interface 103, an ordering system 105, a provisioning system 107, an exception handler 109, a field engineer scheduler and alert manager 111, and a billing system 113. It is contemplated that other services may be supported, and thus, additional and/or different systems may be employed. A systems manager (e.g., 101a and 101b) is responsible for managing operations of one or more source systems by way of a BPM tool operating within these systems 103-113. In one embodiment, systems manager 101 is also responsible for providing a portal for one or more client systems to request and monitor status information relating to the workflow of one or more processes of a workflow that may be predetermined. For purposes of discussion, in this example, source systems and client systems include customer interface 103, ordering system 105, provisioning system 107, exception handler 109, field engineer scheduler and alert manager 111, and billing system 113. In certain embodiments, source systems refer to sources for data, which can be presented in a variety of forms.

For example, systems manager 101 collects or receives files containing data from one or more source systems and processes the data for storing and for reporting a determined status to one or more client systems. The data can be stored in any form of memory local to the source system or centrally, such as metadata database 123. For purposes of illustration, metadata database 123 is depicted as a separate entity from that of systems manager 101a (and manager 101b). However, in exemplary embodiments, systems manager 101 may include the metadata database 123, and/or any other form of memory. The source systems can be associated with a single entity (organization, business, individual, etc.) or multiple distinct entities. Similarly, the client system can be associated with a single entity (organization, business, individual, etc.) or multiple distinct entities. The data collected from the one or more source systems can include data from various sources. For example, the data can be from a single system or multiple systems, can be in the form of online analytical processing (OLAP) cubes built from the metadata database 123 to which data has been uploaded, and can be data that moves from one system to another system, etc. While specific reference will be made thereto, it is contemplated that the system 100 may embody many forms and include multiple and/or alternative components and facilities.

As shown, multiple systems managers 101 may interact with an assessment platform 119, whereby the platform 119 can determine whether migration to one system manager to another system manager is viable; for example, platform 119 assesses these BPM tools to produce assessment scores, as more fully with respect to FIG. 1B. Under the scenario of FIG. 1A, a service provider network 125 may include systems managers 101; under this arrangement, a data processing service can be provided as a managed service by the service provider network 125.

As mentioned, one aspect of operating an entity is the process of executing financial accounting, which may require a great amount of time and effort. In a typical case, financial accounting is periodically executed, for instance, at the end of a particular period (e.g., day, week, month, etc.). During this process, which may be referred to as a periodic close process, the necessary information associated with financial accounting may come from numerous sources, such as the many departments and members within a business entity, other entities that service the business entity, business clients, etc. As a significant portion of financial accounting continues to require manual production, the process of integrating financial data can be a difficult and confusing series of steps, especially because the information may come from multiple sources that may be strongly decoupled and disparate from each other. By way of example, each member associated with the periodic close process (e.g., the various functional or technical teams/members) may utilize different means of communication (e.g., emails, telephone calls, instant messaging, in-person conversations, etc.), and may provide data in different formats, which may cause confusion and/or delay. Moreover, there may be a lack of adequate automated monitoring and status reporting, as well as communication gaps between teams/members. As a result, the close status may not be known to those responsible (e.g., supervisors, executives, etc.) for completing the close process. Although each team may issue “alarms” to other teams for missed files and processes, the “alarms” may not be considered by all of those who are involved in the integration process because of manual and disparate processes (e.g., different means of communication, data delivered in different formats).

As such, systems manager 101 serves as a bidirectional communication gap among one or more of customer interface 103, ordering system 105, provisioning system 107, exception handler 109, field engineer scheduler and alert manager 111 and billing system 113. In other embodiments, the one or more source systems can include a messaging application (e.g., email application, instant messaging application, etc.) and a productivity application (e.g., word processing application, graphic arts application, etc.). Systems manager 101 can be asynchronous system that can provide responses through extensible markup language (XML), web service calls, etc. For example, systems manager 101 can provide asynchronous responses through web service description language (WSDL) calls. Customer interface 103, ordering system 105, provisioning system 107, exception handler 109, field engineer scheduler and alert manager 111 and billing system 113 can communicate with the system 100 using various communications modes.

In certain embodiments, customer interface 103, ordering system 105, provisioning system 107, exception handler 109, field engineer scheduler and alert manager 111 and billing system 113 can communicate with systems manager 101 using web service calls, emails, telephone calls, in-person conversations, instant messaging chats, etc. For example, customer interface 103, ordering system 105, provisioning system 107, exception handler 109, field engineer scheduler and alert manager 111 and billing system 113 may be members of a common entity or organization. In such an example scenario, the supervisors may utilize systems manager 101 to obtain reports containing status information relating to progress of the workflow towards completion, such that status information is estimated by correlating the workflow data with the one or more predetermined processes of a workflow. Systems manager 101 can collect data from some of customer interface 103, ordering system 105, provisioning system 107, exception handler 109, field engineer scheduler and alert manager 111 and billing system 113 via emails, and then, extract the workflow data for use in a format that the users of the others of customer interface 103, ordering system 105, provisioning system 107, exception handler 109, field engineer scheduler and alert manager 111 and billing system 113 are able to utilize.

In some embodiments, customer interface 103, ordering system 105, provisioning system 107, exception handler 109, field engineer scheduler and alert manager 111 and billing system 113 utilize data management systems, wherein data can be stored in one or more data containers. Each container may contain records, and the data within each record may be organized into one or more fields. For example, in relational database systems, the data containers are referred to as tables, the records are referred to as rows, and the fields are referred to as columns. In object-oriented databases, the data containers are referred to as object classes, the records are referred to as objects, and the fields are referred to as attributes. In addition, the one or more data containers may contain user and system profiles. Other database architectures may use other terminology.

Customer interface 103, ordering system 105, provisioning system 107, exception handler 109, field engineer scheduler and alert manager 111 and billing system 113 may include any customer premise equipment (CPE) capable of sending and/or receiving data or information over one or more of networks 115, 117, 121, and 125. For instance, customer interface 103 and billing system 113 may include a voice terminal that may be any suitable plain old telephone service (POTS) device, facsimile machine, etc., a mobile terminal that may be any cellular phone, radiophone, satellite phone, smart phone, wireless phone, or any other suitable mobile device, such as a personal digital assistant (PDA), pocket personal computer, tablet, customized hardware, etc.; a computing device that may be any suitable computing device, such as a VoIP phone, skinny client control protocol (SCCP) phone, session initiation protocol (SIP) phone, IP phone, personal computer, softphone, workstation, terminal, server, etc.

By way of example, customer interface 103 may be managed by a telephone service provider; as such, customer interface 103 can relate to a central office, a tandem office or any other entity that supplies data files to be integrated by systems manager 101. Billing system 113 may be managed by a telephone service provider or any other entity such as a forecasting authority (e.g., National Forecasting and Planning System (NFPS)), different from the telephone service provider that manages customer interface 103, which requires access to the integrated data. Once data such as information associated with the status of the execution of a workflow from each (or any) of customer interface 103, ordering system 105, provisioning system 107, exception handler 109, field engineer scheduler and alert manager 111 and billing system 113 is integrated by systems manager 101, the data (e.g., data associated with the status of a workflow), as well as status information, can be made available each (or any) of customer interface 103, ordering system 105, provisioning system 107, exception handler 109, field engineer scheduler and alert manager 111 and billing system 113 and used for various purposes, such as monitoring or completing a close process (e.g., financial accounting). For example, systems manager 101 may estimate status information relating to one or more processes of a workflow and report such estimated status information to billing system 113. According to certain embodiments, each of customer interface 103, ordering system 105, provisioning system 107, exception handler 109, field engineer scheduler and alert manager 111 and billing system 113 may utilize different data formats for data of common interest to all of customer interface 103, ordering system 105, provisioning system 107, exception handler 109, field engineer scheduler and alert manager 111 and billing system 113. It is noted that incompatibility of data can involve the actual data structure.

According to one embodiment, systems manager 101 makes the converted or integrated data available to the client systems to ensure that the client systems, and any other system, has access to compatible data and status information. In exemplary embodiments, systems manager 101 also provides data, as well as any estimated status information, the source systems.

Systems manager 101, customer interface 103, ordering system 105, provisioning system 107, exception handler 109, field engineer scheduler and alert manager 111 and billing system 113 may communicate over a data network 115, such as the Internet or any other type of public or private network. Various secure file transfer protocols may be used to securely convey files and data to be processed from one or more of customer interface 103, ordering system 105, provisioning system 107, exception handler 109, field engineer scheduler and alert manager 111 and billing system 113 to systems manager 101 and from systems manager 101 to one or more of customer interface 103, ordering system 105, provisioning system 107, exception handler 109, field engineer scheduler and alert manager 111 and billing system 113 over one or more communication links (or connections) 127. For example, the one or more of customer interface 103, ordering system 105, provisioning system 107, exception handler 109, field engineer scheduler and alert manager 111 and billing system 113 may monitor one or more predetermined processes of a workflow and request systems manager 101 to provide an asynchronous response regarding the status of the one or more predetermined processes of a workflow. Links 127 may include wired (e.g. coaxial cable, twisted pair, fiber optic cable) and/or wireless connections.

In the example of FIG. 1A, system 100 includes various communication networks, such as a data network 115 and wireless network 117; these networks 115 and 117 can support telephony services for a mobile terminal to communicate over a telephony network 121 (e.g., Public Switched Telephone Network (PSTN). In this manner, customer interface 103, ordering system 105, provisioning system 107, exception handler 109, field engineer scheduler and alert manager 111 and billing system 113 can place and receive calls from, for example, a voice terminal. For the purpose of illustration, the wireless network 117 can include a radio network that supports a number of wireless terminals, which may be fixed or mobile, using various radio access technologies. According to one exemplary embodiment, radio technologies that can be contemplated include: first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), 4G, etc. For instance, various mobile communication standards have been introduced, such as first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), and beyond 3G technologies (e.g., third generation partnership project (3GPP) long term evolution (3GPP LTE), 3GPP2 universal mobile broadband (3GPP2 UMB), etc.).

Complementing the evolution in mobile communication standards adoption, other radio access technologies have also been developed by various professional bodies, such as the Institute of Electrical and Electronic Engineers (IEEE), for the support of various applications, services, and deployment scenarios. For example, the IEEE 802.11 standard, also known as wireless fidelity (WiFi), has been introduced for wireless local area networking, while the IEEE 802.16 standard, also known as worldwide interoperability for microwave access (WiMAX) has been introduced for the provision of wireless communications on point-to-point links, as well as for full mobile access over longer distances. Other examples include Bluetooth™, ultra-wideband (UWB), the IEEE 802.22 standard, etc.

According to certain embodiments, a service provider network 125 includes systems manager 101; under this arrangement, the process integration (or data processing) service can be provided as a managed service by the service provider 125. It should be noted that various other types of networks may also be present within system 100 and are not limited to the described systems. Subscribers, for example, customer interface 103, ordering system 105, provisioning system 107, exception handler 109, field engineer scheduler and alert manager 111 and billing system 113 are also shown within FIG. 1A in communication with the assortment of networks. It should also be noted that customer interface 103, ordering system 105, provisioning system 107, exception handler 109, field engineer scheduler and alert manager 111 and/or billing system 113 may be associated with one or more of the described networks including the wireless network 117 and the telephony network 121.

FIG. 1B is a flowchart of a process for performing the assessment, according to one embodiment. In this example, assessment platform 119 evaluates systems managers 101 to move from one platform to another, whereby the current manager 101a is denoted as the “source” and the systems manager 101b as the “target.” Additionally, it is assumed that systems managers 101 are configured to run business process management applications. Under this scenario, it is assumed that an assessment of system manager 101a and system manager 101b is performed to determine whether migration from the source system 101a to the target system 101b is viable.

In step 151, assessment platform 119 selects a representative process of a workflow. Thereafter, the representative process is executed, as in step 153, on the source business process management platform 101a as well as the target business process management platform 101b. In step 155, a first set of one or more metric values is captured from the source platform 101a in the execution of the representative process. Similarly, in step 157, a second set of one or more metric values is captured from the target platform 101b in the execution of the representative process. In one embodiment, the first set of metric values and the second set of metric values relate to execution time of the representative process. The assessment platform 119 can identify one or more execution points in program code of the representative process, wherein the execution points are subject to program calls. tagging the points in the program code to log the execution time values. Next, assessment platform 119 generates, per step 159, an assessment score based on the first set of metric values and the second set of metric values. In step 161, a determination is made whether to migrate from the source platform 101a to the target platform 101b based on the assessment score.

According to certain embodiments, the representative process can include multiple subprocesses. Because these subprocesses may not be of equal importance, weighting values can be assigned to these subprocesses according to a prioritization scheme. For example, key functions of the business tool can be deemed higher priority. An assessment score is generated according to the weighting values for each of the platforms 101a and 101b. In one embodiment, if the target platform 101b provides a higher score, then migration from the source platform 101a to the target platform 101b is feasible. To migrate from the source platform 101a to the target platform 101b, program code for the representative process utilized in the source platform 101a is converted into program code compatible with the target platform 101b.

In one embodiment, assessment platform 119 can be accessed by a computer configured with a graphical user interface. In this manner, a user (e.g., administrator) can specify, via the graphical user interface, a group of program modules of the source platform 101a. The assessment platform 119 maps the group of program modules and variable names to a corresponding group of program modules and variable names of the target platform 101b. A converted version of the group of program modules and variable names is generated based on the mapping. The location of the placement of the converted version of the group of program modules and variable names is indicated.

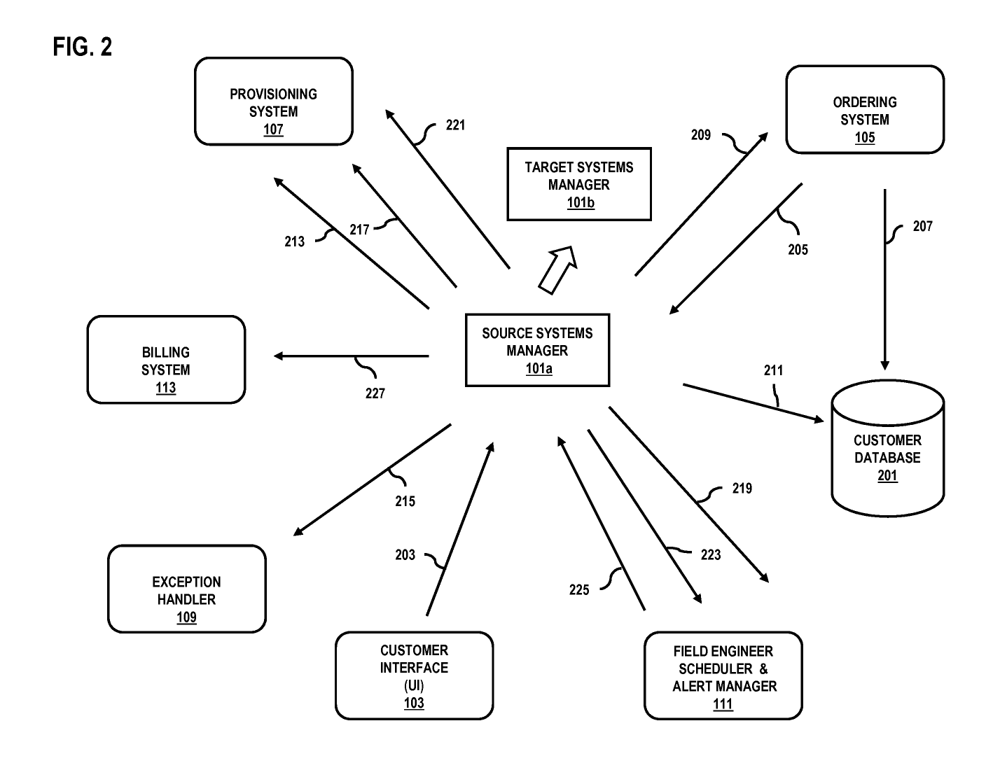

FIG. 2 is a diagram of a use case involving a systems manager supporting provisioning of telecommunication services, according to one embodiment. In one embodiment, either of the systems managers 101a or 101b is configured to interact with the operation and support systems 103-113 to provision services for customers. As shown, source systems manager 101a can be migrated to target systems manager 101b to provide similar functions, but with greater efficiency, etc. By way of example, a user (or customer) orders a new data provider connection involving the ordering system 105, which creates or retrieves account information associated with the requesting customer from customer database 201. In this example, the user, via the customer interface 103, contacts systems manager 101, per step 203.

If the customer account information already exists, the required customer data is extracted from customer database 201. For example, systems manager 101 contacts ordering system 105, as in step 205, to access the customer's account history. Ordering system 105 fetches the customer's details from customer database 201, as in step 207. Ordering system 105 then provides the customer details to systems manager 101, as in step 209.

If the customer does not exist, the customer data is gathered via known input systems and is appropriately recorded. Systems manager 101 then adds the customer's details to customer database, as in step 211.

At this time, the request is passed to ordering system 105 and provisioning system 107. Subsequently, ordering system 105 records the order; and the order is additionally recorded in billing system 113.

Systems manager 101 then calls/invokes provisioning system 107, which determines the type of provisioning is required for this particular customer. Systems manager 101 checks with provisioning system 107, as in step 213, to determine whether the provisioning of the order is permitted (e.g., the particular customer may be restricted from certain services depending on any prerequisite services, or service availability may be confined to location, etc.). If provisioning of the order is not permitted, then the order is passed to exception handler 109, as in step 215. Exception handler 109 may be configured with specific protocols to respond to the impermissibility of the order; non-limiting examples of such response include requesting the customer to order other prerequisite services. If provisioning of the order is permitted for the customer, provisioning system 107 then secures any new materials that may be required for fulfillment of the order.

Systems manager 101 then passes the provisioning details to a field engineer via field engineer scheduler and alert manager 111, as in step 219. Field engineer scheduler and alert manager 111 then creates a schedule as to when the installation will be performed at the customer's premises; this schedule can be based on the availability of the field engineer.

Systems manager 101 contacts provisioning system 107, as in step 221, to ensure that the materials (that were secured as part of the order) are received on time. If the materials are not received by the due date, an exception is raised by exception handler 109. Further, if the materials are not received on time, an alert may be generated by field engineer scheduler and alert manager 111, as in step 223. At the scheduled time/date, systems manager 101 reminds the field engineer via field engineer scheduler and alert manager 111 of the provisioning to be performed for the order. Once the field engineer provisions the order, he/she updates system manager 111, which then updates all relevant systems about the completion of the order, as in step 225. Finally, systems manager 101 contacts billing system 113, which launches the billing procedure for invoicing the customer, as in step 227.

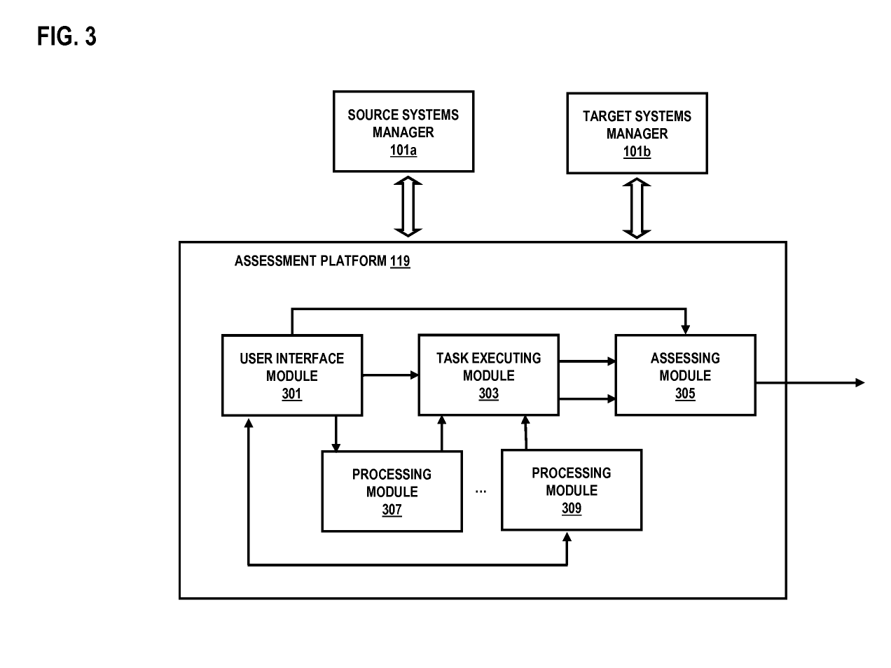

FIG. 3 is a diagram of a systems manager 101 and an assessment platform 119, according to an exemplary embodiment. As shown, assessment platform 119 can include various components to perform the assessment process of FIG. 1B: a user interface module 301, a process executing module 303, an assessing module 305, and one or more processing modules 307 and 309.

Assessment platform 119 is configured to receive signals (e.g., messages) from systems managers 101a and 101b. User interface module 301 is operable to receive and/or transmit instruction signals and data to the processing modules 307 and 309, task executing module 303, and assessing module 305. User interface module 301 may include any known output device, non-limiting examples of which include an earphone or speaker, a ringer, a microphone, and a display. User interface module 301 may additionally include any known input device, non-limiting examples of which include a touch sensitive display, a key pad, a joystick and a mouse. User interface module 301 enables a user to manipulate assessment platform 119 and enables assessment platform 119 to indicate the effects of the users' manipulation.

In one embodiment, processing module 307 can execute code corresponding to the BPM tool of source systems manager 101a, while processing module 309 can be allocated to the execution of the BPM tool associated with target systems manager 101b.

Process executing module 303 is able to execute a representative process of a workflow using the source BPM tool within processing module 307 and then to execute the representative process of the workflow using the BPM tool within processing module 309. Process executing module 303 is able to measure predetermined metrics of the operation of each BPM. Non-limiting examples of such predetermined metrics include execution time, processing power, memory allocation and memory access time. The values of the measure predetermined metrics corresponding to the execution of a representative process of the workflow using the source BPM tool within processing module 307 can then be provided to assessing module 305.

Assessing module 305 can compare the operation of the execution of a representative process of a workflow using the source BPM tool within processing module 307 with the execution of the representative process of the workflow using the BPM tool within processing module 309. In this manner, assessment platform 119 can determine whether to migrate from source systems manager 101a to target systems manager 101b.

According to one embodiment, each of user interface module 301, process executing module 303, assessing module 305, processing module 307 and processing module 309 is a distinct device and/or processes (e.g., applications). However, in other embodiments, at least two of user interface module 301, process executing module 303, assessing module 305, processing module 307 and processing module 309 may be combined as a unitary device. Further, in some embodiments at least one of user interface module 301, process executing module 303, assessing module 305, processing module 307 and processing module 309 may be implemented as a non-transitory computer-readable media for carrying or having computer-executable instructions or data structures stored thereon. Such non-transitory computer-readable media can be any available media that can be accessed by a general purpose or special purpose computer. Non-limiting examples of non-transitory computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a non-transitory computer-readable medium. Thus, any such connection is properly termed a non-transitory computer-readable medium. Combinations of the above should also be included within the scope of non-transitory computer-readable media.

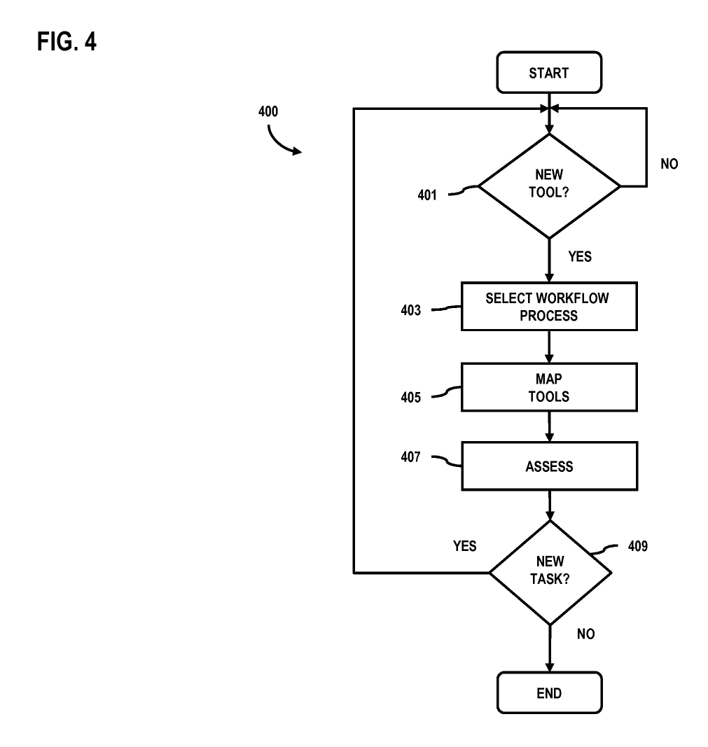

FIG. 4 is a flowchart of a process 400 for assessing the performance of tow BPM tools for a processing system, according to an exemplary embodiment. As shown in FIG. 4, process 400 determines whether a target BPM platform (e.g., platform 101b of FIG. 1) is to be analyzed, per step 401. For example, initially a current BPM that is managing the services of systems manager 101 may be residing in processing module 307. A new BPM may be loaded into processing module 309, for purposes of comparing to the current BPM in processing module 307. The new BPM may be loaded into processing module 309 by any known method; a non-limiting example of which includes via user interface module 301 instructing processing module 309 to accept a non-transitory computer-readable media that stores a software version of the new BPM.

If a target BPM platform is not to be analyzed, then process 400 waits until a target BPM platform is to be analyzed (return to step 401). In one example embodiment, either one of user interface module 301 or processing module 309 may provide message to systems manager 101 when a target BPM platform (e.g., platform 101b) is to be analyzed. In such an example embodiment, it may be determined that the target BPM platform 101b is not to be analyzed without receipt of such a message.

If the target BPM platform 101b is to be analyzed, a representative process of a workflow for execution by the source BPM platform 101a and the target BPM platform 101b is generated (per step 403). In one embodiment, a user may choose a representative process of a workflow for the source BPM platform 101a and the target BPM platform 101b to execute. For example, via user interface module 301, a user may choose a specific process of a workflow.

Returning to FIG. 1A, for purposes of discussion, a representative process of a workflow to be analyzed includes a customer ordering a new data service. In this example, the workflow can be a composition of five sub-processes involving, among other activities,: accessing metadata database 123, retrieving data from metadata database 123, accessing customer interface 103, ordering system 105, provisioning system 107, exception handler 109, field engineer scheduler and alert manager 111 and billing system 113, retrieving data from customer interface 103, ordering system 105, provisioning system 107, exception handler 109, field engineer scheduler and alert manager 111 and billing system 113, and processing the retrieved data.

In other embodiments, a predetermined representative process of a workflow may be utilized for situations where a target BPM platform is to be assessed. Returning to FIG. 3, irrespective of whether the representative process of a workflow is selected by the user via user interface module 301 or whether the representative process of a workflow is predetermined, the representative process of the workflow is provided to process executing module 303.

Returning to FIG. 4, now that a representative process of a workflow has been generated, the source BPM platform is mapped to the target BPM platform (step 405).

It is contemplated that the source BPM platform 101a may operate/function differently from the target BPM platform 101b. Continuing with the example that the representative process of the workflow is a customer ordering a new data service as discussed above, the source BPM platform 101a performs the following activities: access metadata database 123, retrieve data from metadata database 123, and process the retrieved data from metadata database 123; then will access ordering system 105, retrieve data from customer database 201, and process the retrieved data from customer database 201; and so on. Also, the target BPM platform 101b may execute the following activities for the representative workflow: access metadata database 123, ordering system 105 and customer database 201; then will retrieve data from metadata database 123 and from customer database 201; and so on. To compare the source BPM platform 101a with the target BPM platform 101b in terms of performance with respect to the representative process, execution of each similar sub-process are compared. However, in order to compare each similar sub-process, the similar sub-processes are first determined. This can be accomplished by mapping the source BPM platform 101a to the target BPM platform 101b.

Returning to FIG. 3, in an example embodiment, user interface module 301 instructs processing module 307 to use the source BPM platform 101a to execute the representative process of the workflow; in this case, the process involves a customer ordering a new data service. In response, processing module 307 communicates with the executing module 303, whereby the source BPM platform's software code to execute the representative process of the workflow is conveyed. User interface module 301 additionally instructs processing module 309 to use code corresponding to the functions of the target BPM platform 101b to execute the representative process of the workflow. In response, processing module 309 provides the target BPM platform's software code to executing module 303 to perform the representative process.

At this point process executing module 303 can map the source BPM platform's software code associated with the representative process to the target BPM platform's software code.

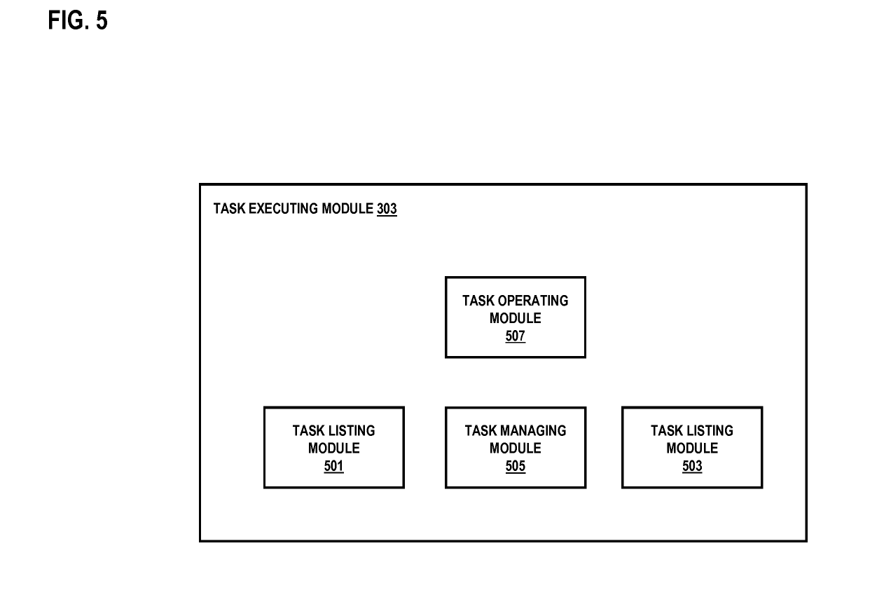

A more detailed discussion of an example of mapping the source BPM platform to the target BPM platform will now be provide with reference to FIGS. 5-11.

FIG. 5 is a diagram of a process executing module utilized in the system of FIG. 3, according to an exemplary embodiment. As illustrated in FIG. 5, executing module 303, according to one embodiment, includes a process listing module 501, a process listing module 503, a process managing module 505, and a process operating module 507. These modules 501-507 can be implemented by hardware, firmware, software, or a combination thereof, and as separate or combined components.

In operation, in this example embodiment, each of process listing module 501, process listing module 503, process managing module 505 and process operating module 507 may receive input by the user via user interface module 301. In particular, a user may import a new representative process of the workflow for comparison. It should be noted that in other example embodiments, each of process listing module 501, process listing module 503, process managing module 505 and process operating module 507 operate automatically.

Process listing module 501 is loaded with the source BPM platform's software code to execute the process. Process listing module 501 then parses (or breaks down) the source BPM platform's software code into a list of distinct executable processes. This list of distinct executable processes are provided to process managing module 505. Similarly, process listing module 503 is loaded with the target BPM platform's software code to execute the representative process of the workflow, wherein a list of distinct executable processes are generated and provided to process managing module 505. At this point, process managing module 505 is able to map the list of distinct executable processes of the source BPM platform's software code to the list of distinct executable processes of the target BPM platform's software code.

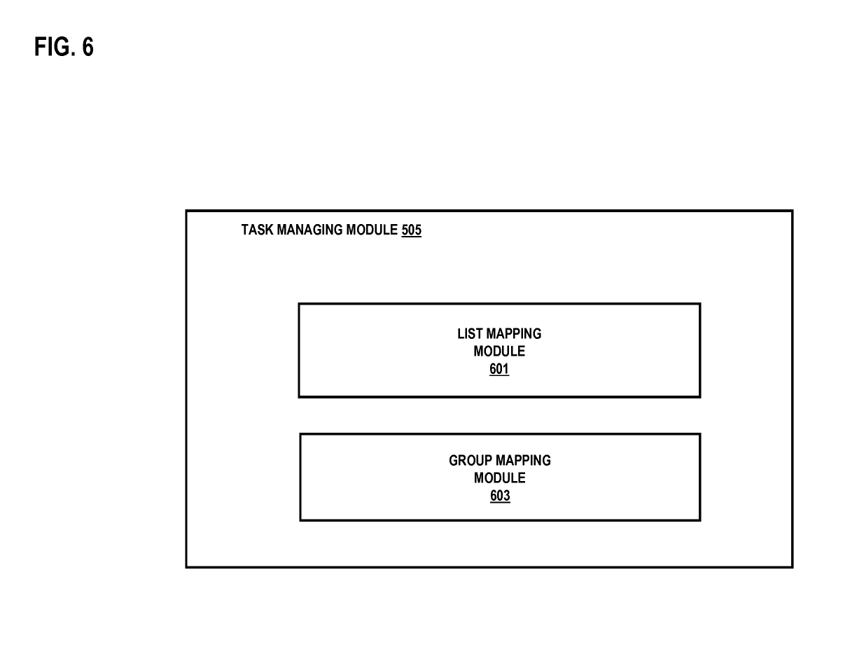

A more detailed discussion of an example of process managing module 505 is provided with reference to FIG. 6.

FIG. 6 is an example process managing module 505 of process executing module 303 of FIG. 5, according to an exemplary embodiment. As illustrated in FIG. 6, process managing module 505 includes a list mapping module 601 and a group mapping module 603. In one embodiment, list mapping module 601 and group mapping module 603 are distinct devices and/or processes (e.g., applications). Alternatively, list mapping module 601 and group mapping module 603 may be combined as a unitary device. Further, in some embodiments at least one of list mapping module 601 and group mapping module 603 may be implemented as a non-transitory computer-readable media for carrying or having computer-executable instructions or data structures stored thereon.

List mapping module 601 is operable to map a distinct executable processes of the source BPM platform's software code to a similar distinct executable processes of the target BPM platform's software code. In some situations, a distinct executable processes of the source BPM platform's software code may not be similar to a distinct executable process of the target BPM platform's software code. Accordingly, group mapping module 603 is operable to map one or more distinct executable processes of the source BPM platform's software code to a similarly functioning group of distinct executable processes of the target BPM platform's software code.

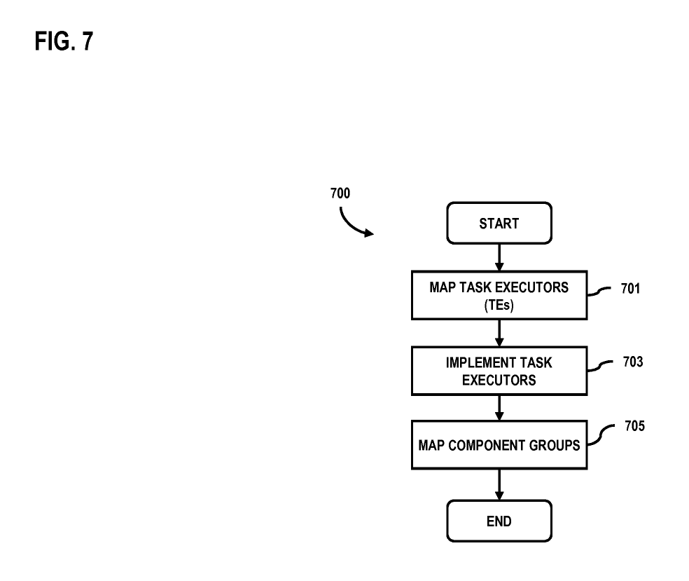

In some instances, the target BPM platform's software code may need to be converted to an equivalent type of code of that of the source BPM platform. In an example embodiment, specific points in the target and source BPM platform's software code are identified and tagged. Accordingly, the times that the tagged portions of the target and source BPM platform's software code are called for execution are known. The time logs may then be compared, for example. This will be further described with reference to FIG. 7.

FIG. 7 is a flowchart of an example conversion process 700, according to an exemplary embodiment. As shown in FIG. 7, process 700 creates a map of each logical task executor, as in step 701. A task executor may be considered a method or functionality and refers to a module that performs a specific task. For purposes of explanation one task executor can involve the systems manager 101 making a call to customer database 201. When creating a map of each logical task executor, each logical task executor from the source BPM platform 101a is mapped to the corresponding logical task executor in the target BPM platform 101b. In certain embodiments, at least one task executor may correspond to a subprocess of the representative process of workflow.

The task executors can be implemented in the target BPM platform 101b, per step 703. In an example embodiment, a sub-set of all the task executors may also be implemented in the target BPM platform 101b. Accordingly, an initial assessment of whether to migrate to the target BPM platform 101b may be made without executing all the task executors. This approach advantageously minimizes use of resources.

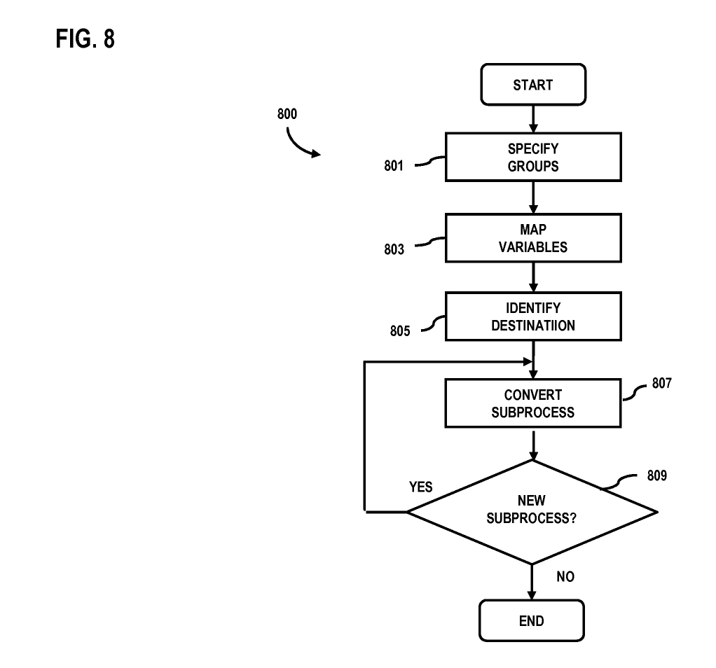

In step 705, the component groups from the source BPM platform 101a are mapped to component groups of the target BPM platform 101b. For example, a task executor in the source BPM platform 101a may map to one or more task executors in the target BPM platform 101b. This mapping process is further explained with respect to FIG. 8.

FIG. 8 is a flowchart of an example of process for mapping tools, according to an exemplary embodiment. Continuing with the example of FIG. 4, process 800 specifies groups of processes/programs, per step 801. For example, similar distinct executable processes of the source BPM platform's software code and the target BPM platform's software code are mapped by list mapping module 601; and similar groups of distinct executable processes of the source BPM platform's software code and the target BPM platform's software code are mapped by group mapping module 603.

Next, variables from the target BPM platform 101b are mapped to variables from the source BPM platform 101a, as in step 803. This action may be optional, depending on whether either BPM tool software code has assigned variables, e.g., local or global variables within the code. If assigned variables exist, list mapping module 601 may map similar variables of the source BPM platform's software code and the target BPM platform's software code.

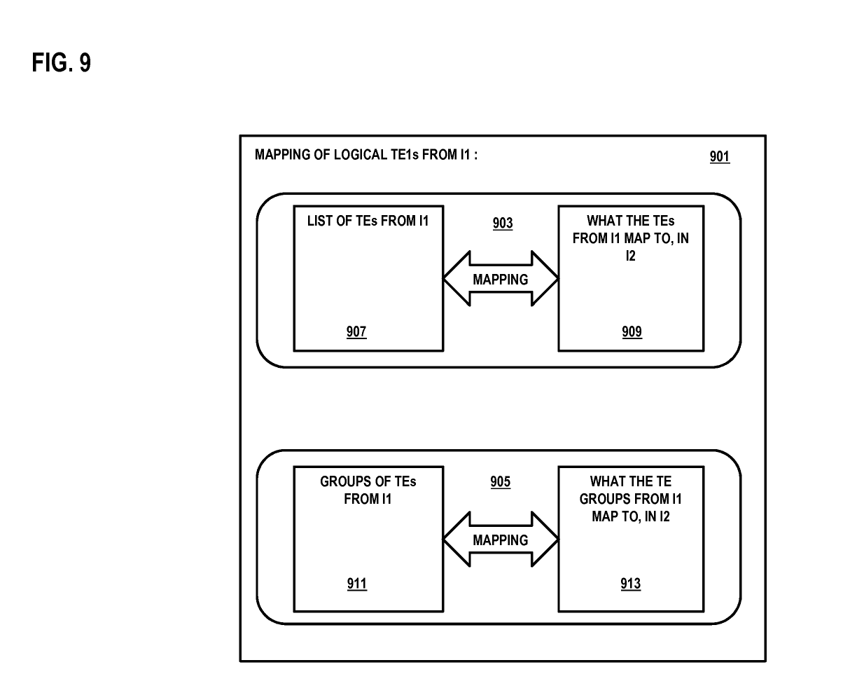

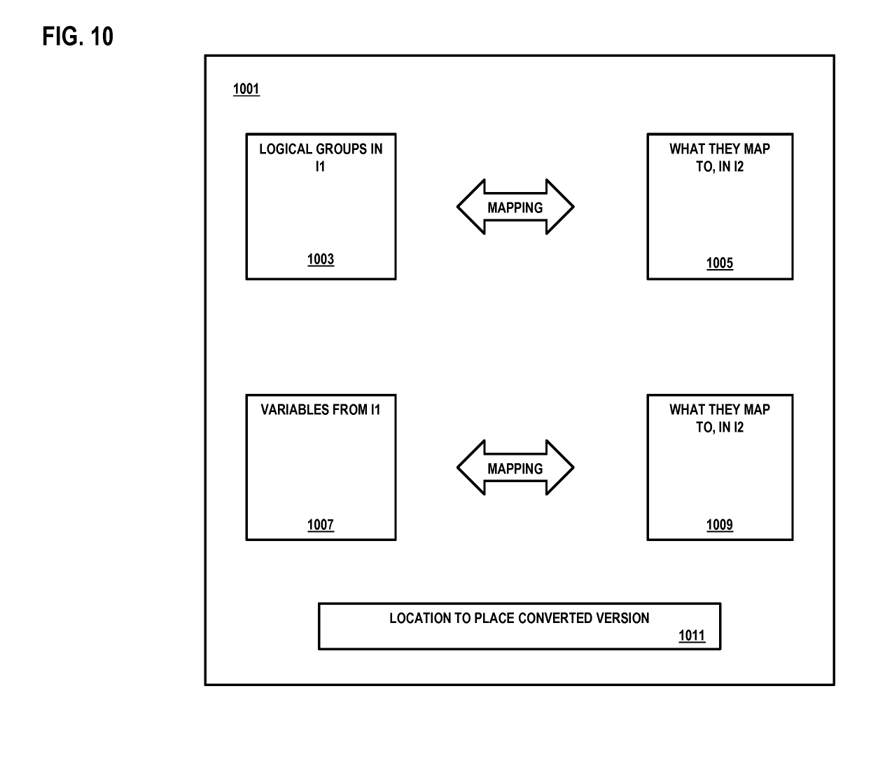

In an example embodiment, mapping of groups and variables from one BPM platform to another BPM platform may be performed via a graphical user interface, as described with respect to FIGS. 9 and 10.

FIG. 9 illustrates an example image of a graphical user interface for mapping a representative process of a workflow from a target BPM platform's software code to a source BPM platform's software code, according to one embodiment. Graphical user interface 901 includes a task executor portion 903 and a component group portion 905. Task executor portion 903 utilizes a list portion 907 and a list portion 909. Component group portion 905 includes a group list portion 911 and a group list portion 913.

In this example, a user may list task executors of the target BPM platform 101b in list portion 907. The user may then list, in list portion 909, the particular listed task executors in list portion 907 corresponding to task executors of source BPM platform 101a. In this example, the user may list groups of task executors of the target BPM platform 101b in list portion 911. The user may then may list, in list portion 913, which listed groups of task executors in list portion 911 correspond to task executors of source BPM platform 101a.

FIG. 10 illustrates another example image of a graphical user interface 1001 for mapping a representative process of a workflow from a target BPM platform's software code to a source BPM platform's software code, in accordance with one embodiment. Graphical user interface 1001, according to one embodiment, includes a logical groups list portion 1003, a mapped list portion 1005, a variable list portion 1007, a mapped list portion 1009 and a location portion 1011.

By way of example, a user may list logical groups of task executors of the target BPM platform 101b in logical groups list portion 1003. The user may then list, in mapped list portion 1005, which listed logical groups of task executors in list portion 1003 correspond to task executors of source BPM platform 101a. The user may then list variable of the target BPM platform 101b in variable list portion 1007. The user may then list, in mapped list portion 1009, the listed variable in variable list portion 1007 corresponding to variable of source BPM platform 101a. In this example, location portion 1011 indicates where to store the converted version of the target BPM platform.

Returning to FIG. 8, once the variables of the target BPM platform have been mapped to the variables of the source BPM platform 101a, the destination for storing the results is identified, per step 805. The results of the execution of the representative process of the workflow, e.g., metrics to be measured as will be discussed in greater detail below, are stored for further processing. In an example embodiment, the results can be stored in assessing module 305 as illustrated in FIG. 3. Further, a user may define this storage via location portion 1011 as discussed above with reference to FIG. 10.

A subprocess from the new BPM is then converted to a corresponding subprocess of the current BPM (step 807). For example, as systems manager 101 is currently using the source BPM platform to manage processes, the code used by the current BPM should be used to complete a representative process of a workflow. As such, the representative process of the workflow to be executed should be executed using the source BPM platform's software code.

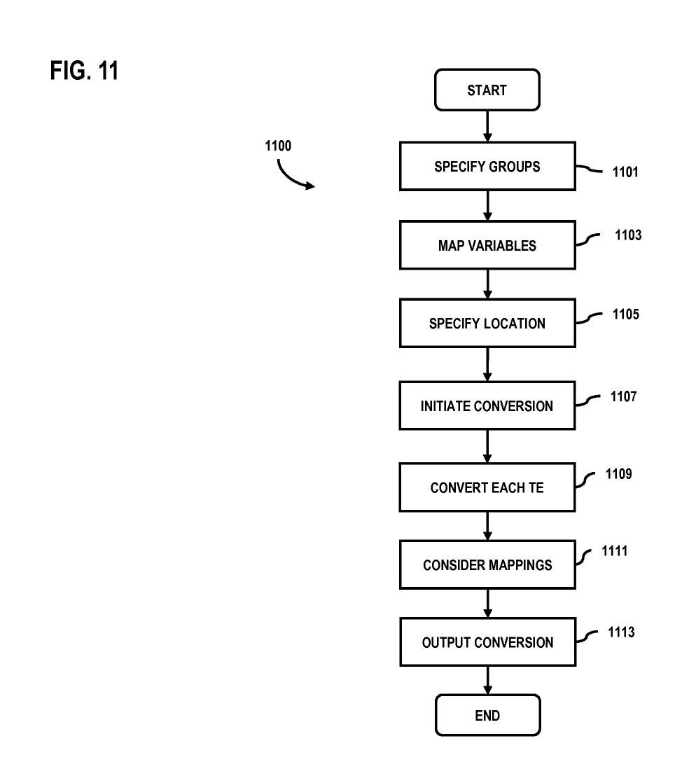

In this example, the target BPM platform's software code for accessing metadata database 123 can be converted to the source BPM platform's software code for accessing metadata database 123. An example conversion process is described with reference to FIG. 11.

FIG. 11 is a flowchart of an example of conversion process 1100, according to an exemplary embodiment. Process 1100 first specifies the particular groups of processes, as in step 1101. For example, the user may specific the logical groups in the target BPM platform 101b that map to the source BPM platform 101a. For purposes of discussion, a predetermined number (e.g., 10) of task executors may together form a logical group in the source BPM platform 101a, whereas three of these may form a single logical group in the target BPM platform 101b, and the remaining seven form another logical group in the target BPM platform 101b. For example, as discussed above with reference to FIG. 9, tasks that may be executed by provisioning system 107 and by ordering system 105 may be one module in source BPM platform 101a, whereas, in target BPM platform 101b, tasks executed by provisioning system 107 might be implemented separately from tasks executed by ordering system 105.

In step 1103, variables may be mapped. For example, as discussed above with reference to FIG. 10, the user might optionally map the variable names from the target BPM platform 101b to the source BPM platform 101a. In an example embodiment, if variables are not mapped, then the same names are assumed for conversion purposes.

In step 1105, the location for storing the conversion is specified (1107). For example, as discussed above with reference to FIG. 10, the location to place the converted version is specified at location portion 1011 by the user through graphical user interface 1001.

At this point, the conversion process is performed for each task executor (step 1107). For example, consider the case where BPM tools (e.g., Adobe® QLink and jBoss® jBPM) are the source BPM platform 101a and target BPM platform 101b, respectively. In QLink, a systems manager is considered as a single big object. An exemplary systems manager operation is as follows:
Start→Contact Database→Gather required info from the database→Call Branch-ProcessInfo→The output from Branch1 is passed onto System1→System1's result is then passed onto System2→Call Branch-ProcessSystem2Output→Feed the result to EndUserInterface→Stop.

In this example, ‘Branch’ (which is also another systems manager) denotes something similar to a method call, which does some processing. In jBPM, there are some basic differences with QLink such as: 1) each branch is a separate object in jBPM (whereas in QLink, the entire systems manager is one single object); 2) the way the parameters are passed to the branches and how the results are passed back also differ between QLink and jBPM—in QLink, all the parameters/variables are global, whereas, in jBPM, they might be local/global—further, local parameters need to be passed specifically—the converter would identify the parameters to be passed and pass it the way jBPM wants the parameters.

Returning to FIG. 11, each task executor is converted (per step 1109). For example, the underlying code in the target BPM platform is reviewed, each task executor is analyzed and converted into code that is compatible with the code of source BPM platform.

The mappings are additionally considered (per step 1111). For example, during the conversion, the mappings of groups and variable names, if specified by the user as discussed above with reference to FIGS. 9 and 10, are taken into consideration.

In step 1113, the conversion is then performed. For example, the code of the target BPM platform 101b, that has now been converted into corresponding code of the source BPM platform 101a is then placed in the user-specified location, e.g., the location provided in location portion 1011, and the user is notified.

Returning to FIG. 8, once the subprocess is converted, the process 800 then determines whether there is another subprocess (per step 809). In some embodiments, assessment platform 119 is configured to assess the target BPM platform 101b on the basis of a single predetermined subprocess. In other embodiments, assessment platform 119 permits assessment of target BPM platform 101b on the basis of a single subprocess as chosen by a user, for example by way of user interface module 301. In yet other embodiments, assessment platform 119 assesses a target BPM platform on the basis of multiple predetermined subprocesses, or multiple subprocesses that are specified by a user, for example by way of user interface module 301.

Returning to FIG. 5, in an example embodiment, a user may view the listed subprocesses within process managing module 505 via user interface module 301. The user may then decide how many, or which subprocesses should be executed to complete an assessment of the BPM tools. Clearly, as the number of subprocesses that are completed increases, the user will obtain a better assessment of the BPM tools for comparison. However, as the number of subprocesses that are completed increases, so does the resource time and energy.

If it determined that there is another subprocess to assess, per step 809, then the next subprocess is converted (step 807). This will repeat until all the subprocesses within the new BPM are converted to corresponding subprocesses of the current BPM.

Returning to FIG. 5, once the subprocesses are converted, the representative process of the workflow is executed by process operating module 507 using the source BPM platform software code and using the target BPM platform software code.

Returning to FIG. 4, now that the source BPM platform has been mapped to the target BPM platform (step 405), the execution of the representative process of the workflow by the source BPM platform 101a and the execution of the representative process of the workflow by the target BPM platform 101b is assessed (step 407). Process 400 can also determine whether other tasks need to be assessed, per step 409.

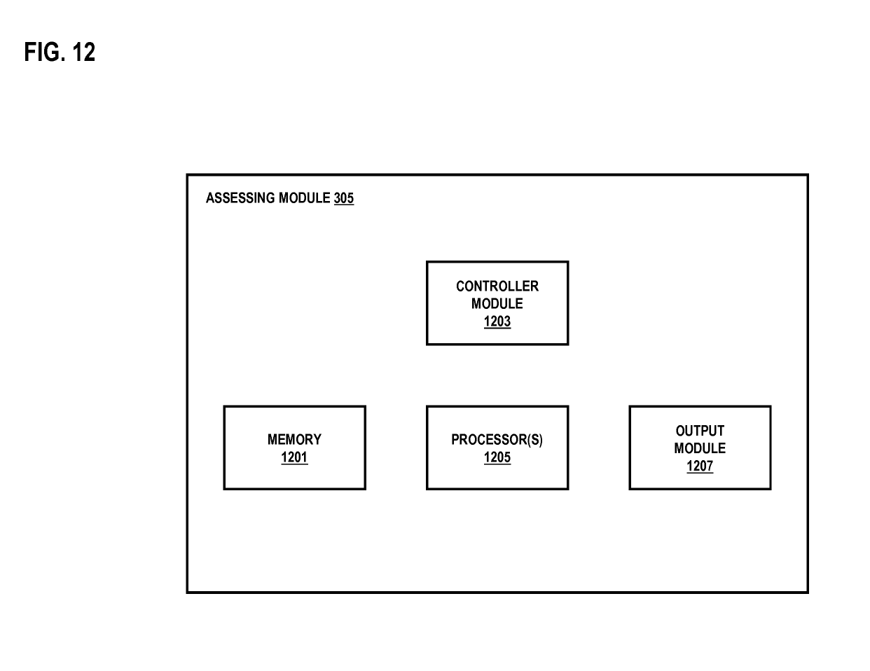

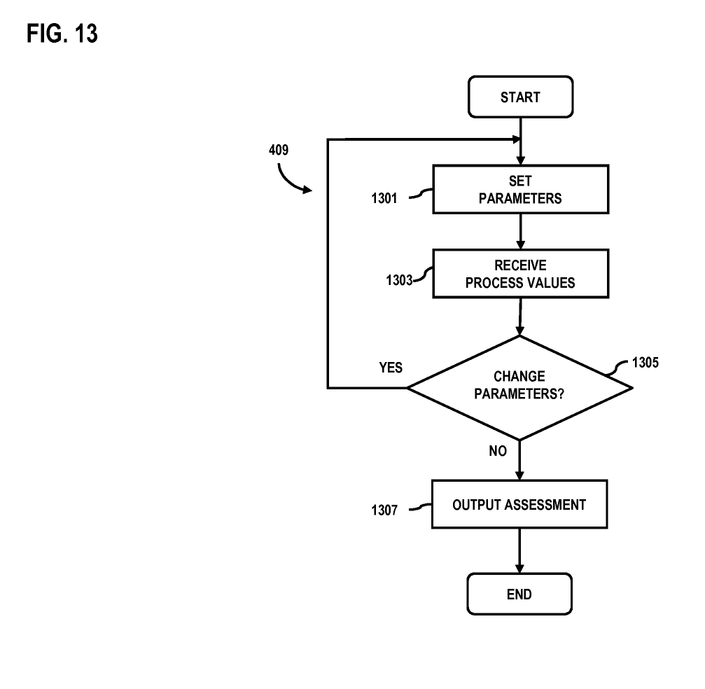

Further details of the operations of assessing module 305 are provided with reference to FIGS. 12 and 13.

FIG. 12 is an example assessing module 305 of assessment platform 119 of FIG. 3, according to an exemplary embodiment. As illustrated in FIG. 12, assessing module 305 includes a memory 1201, a controller module 1203, one or more processors 1205 and an output module 1207. Controller module 1203 can instruct the processing module 1205 to execute various processes and algorithms in support of the assessment process of FIG. 1B and 13. Namely, an assessment score can be generated based on weighted metric values stored in memory 1201. The output module 1207 can present the assessment information or score in various forms.

In this example, each of memory module 1201, controller module 1203, processing module 1205 and output module 1207 are distinct devices. However, in other embodiments, at least two of memory module 1201, controller module 1203, processing module 1205 and output module 1207 may be combined as a unitary device. Further, in some embodiments at least one of memory module 1201, controller module 1203, processing module 1205 and output module 1207 may be implemented as a non-transitory computer-readable media for carrying or having computer-executable instructions or data structures stored thereon.

FIG. 13 is a flowchart of an example of process for assessing of FIG. 5, according to an exemplary embodiment. Continuing with the example of FIG. 4, process 1300 configures various metrics to be used for the assessment—e.g., generation of an assessment score. In some embodiments, assessment platform 119 assesses BPM tools with respect to a single predetermined metric; non-limiting examples of which include execution time, processing power, memory allocation and memory access time. In other embodiments, assessment platform 119 is designed so as to assess BPM tools with respect to a single predetermined metric as chosen by a user, for example by way of user interface module 301. In yet other embodiments assessment platform 119 analyzes and evaluates BPM tools with respect to multiple predetermined metrics. In still other embodiments, assessment platform 119 is designed so as to assess BPM tools with respect to multiple user-specified predetermined metrics.

In an example embodiment, controller module 1203 is arranged to provide the predetermined metric(s). In other embodiments, a user may view the listed metrics within controller module 1203 via user interface module 301. The user may then decide how many, or which metrics should be used to evaluate each BPM tool.

For purposes of discussion, a user selects execution time and memory allocation to be metrics for evaluating each BPM tool.

The process values are then received (per step 1303). In an example embodiment, memory module 1201 receives the results of the execution of the representative process of the workflow by the source BPM platform software code. In other words, in this example embodiment, memory module 1201 is the destination provided in step 805 (FIG. 8). Similarly, memory module 1201 receives the results of the execution of the representative process of the workflow by the target BPM platform software code.

It is then determined whether the metrics for assessment are to be changed (step 1305). Here, the user has an opportunity to further compare the source BPM platform 101a with the target BPM platform 101b. For example, if the originally selected metric(s) do not provide sufficient data for the user to determine a notable difference between the two BPM tools, the user may select additional metrics for assessment.

If it is determined that the metrics for assessment are to be changed, then the metrics are set accordingly (as in step 1301). For example, a user may view the listed metrics within controller module 1203 via user interface module 301. The user may then decide how many more, or which metrics should additionally be used to evaluate each BPM tool. However, if no change is needed, the assessment (e.g., score) is output, as in step 1307. Depending on the requirements of the migration strategy, the weighting scheme can be employed with a thresholding mechanism to automatically determine whether migration is feasible. A typical use case is described below with respect to the factors that are considered in the assessment.

In some embodiments, if more than one metric is used to evaluate each BPM tool, then the results of each metric for each BPM tool may be provided to the user. For example, as discussed above, the user may be notified that: the source BPM platform 101a takes 4 μs to access metadata database 123, whereas the target BPM platform 101b takes 6 μs to access metadata database 123; and the source BPM platform 101a allocates 228 KB of memory, whereas the target BPM platform 101b allocates 124 KB. The tradeoff between processing time and memory requirement can be formulated in the weighting scheme, as well as configuration of thresholds.

In some embodiment, if more than one metric is used to evaluate each BPM tool, an algorithm may be used to combine unlike, compared values. Further a weighting value may be applied to the compared values of each metric. The algorithm may then use the weighted values to generate a single assessment score to evaluate the BPM tools. The weighted values may be derived based on a prioritization scheme, wherein the metrics to be used in an evaluation are prioritized. Accordingly, the weighting values increase in accordance with the priority of their associated metrics. Non-limiting examples of metrics, listed in a non-limited example of priority, include: a) technologies used in the systems/business-suite employed in the business and compatibility of systems manager 101 implementation to the business-suite; b) inter-process communication within the systems (and compatibility with them); c) speed of response when communicating with various systems/applications used in the firm's business-suite; d) which technology is more compatible (i.e., fits in better) in the existing business-suite—sometimes, a system based upon Java® might be preferred, and in some cases, a .Net based system may be apt to use; e) features in systems manager 101 that are essential—at times, certain implementations of systems manager 101 might have certain features, which may not be available in all the systems, and which might be essential to the firm's business processes; f) the amount of parallel processing that can be done by systems manager 101 (maybe something like contacting several systems in parallel, i.e., simultaneously)—some businesses might need high amount of parallel tasks; and g) customization required in the existing implementation of systems manager 101—some businesses might require customization, and so, they may need to choose the implementation accordingly.

In certain embodiments, an algorithm is employed to combine the difference in access time and a difference in allocated memory. Further, if it is determined by the assessment platform 119 that reducing access time is more important than reducing an amount of allocated memory, the algorithm may be modified such that the access time metric is multiplied by a first weighting value and the allocated memory metric is multiplied by a second weighting value, wherein the first weighting value is larger than the second weighting value.

For purposes of discussion, the metric of access time has an associated weighting value of 0.7, and the metric of memory allocation has an associated weighting value of 0.3. Further, the source BPM platform 101a may take 4 μs to access metadata database 123, whereas the target BPM platform takes 6 μs to access metadata database 123; and the source BPM platform 101a allocates 228 KB of memory, whereas the target BPM platform 101b allocates 124 KB. Here, the source BPM platform takes 2 μs less time to access metadata database 123, but allocates 124 KB more memory. In this example, the metric of access time has a weighting value of 0.7, which is greater than the amount of the weighting value of the metric of memory allocation (0.3). Accordingly, in this example, the algorithm may then use generate a single assessment score indicating that the source BPM platform 101a is better than the target BPM platform 101b. Under this scenario, the assessment platform 119 determines that no migration is needed.

Returning to FIG. 4, now that the execution of the representative process of the workflow by the source BPM platform 101a and the execution of the representative process of the workflow by the target BPM platform 101b has been assessed (per step 407), it is determined whether the source BPM platform 101a and the current PBM tool should be assessed with respect to executing a new representative process of a workflow (per step 409). For example, if the originally selected representative process of a workflow does not provide sufficient data for the user to determine a notable difference between the two BPM tools (e.g., platforms 101a and 101b), the user may select an additional representative process of a workflow for assessment.

If it is determined that the representative process of the workflow for assessment is to be changed, then a new representative process of a workflow is generated (per step 401). Otherwise, if it is determined that the source BPM platform 101a and the current PBM tool should not be assessed with respect to executing a new representative process of a workflow, then a determination is made as to whether to migrate to the target BPM tool. If the user determines, based on the assessment score, to migrate to the target BPM tool, then the target BPM tool is installed for use by systems manager 101. If the user determines, based on the assessment score, not to migrate to the target BPM tool, then the source BPM tool remains.

If it is determined that the source BPM platform 101a and the current PBM tool should be assessed with respect to executing a new representative process of a workflow, then a new representative process of a workflow is generated (per step 403).

Moreover, a user may easily compare assessment values of a source BPM platform 101a with the assessment values of a target BPM platform 101b, with respect to selected metrics, as the BPM tools execute a selected representative process of a workflow. Accordingly, a user (or organization) may readily determine which BPM tool is better suited for completing the representative process of the workflow. This approach advantageously avoids incurring the cost of a total migration to a BMP tool prior to assessing key processes

The processes described herein for programmatic assessment may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

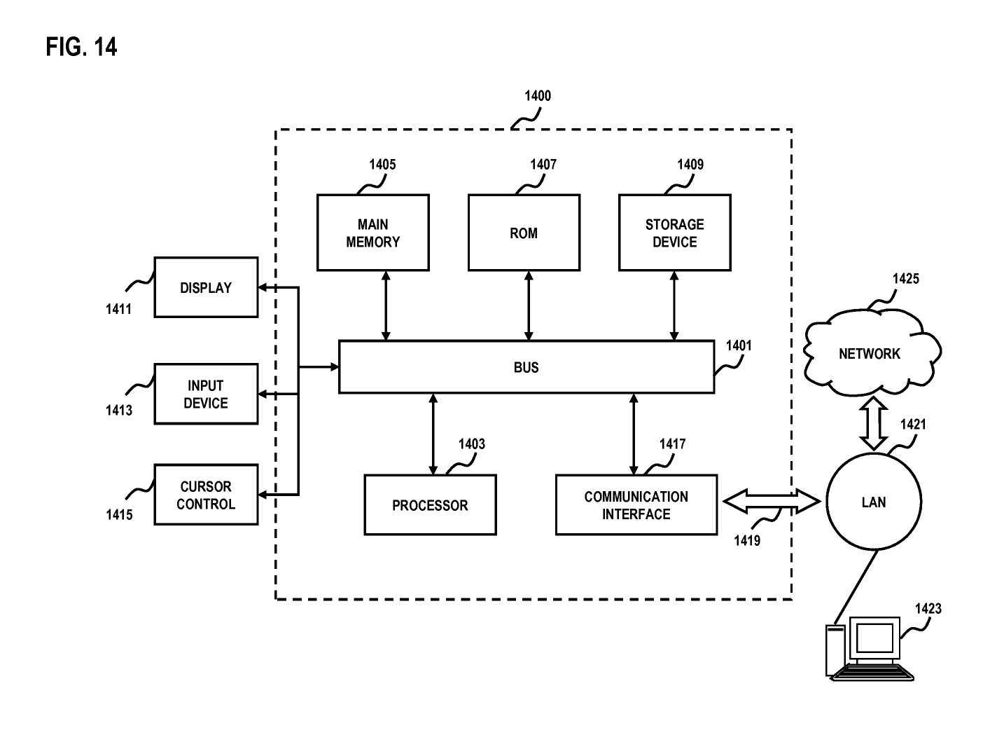

FIG. 14 illustrates computing hardware (e.g., computer system) 1400 upon which exemplary embodiments can be implemented. The computer system 1400 includes a bus 1401 or other communication mechanism for communicating information and a processor 1403 coupled to the bus 1401 for processing information. The computer system 1400 also includes main memory 1405, such as a random access memory (RAM) or other dynamic storage device, coupled to the bus 1401 for storing information and instructions to be executed by the processor 1403. Main memory 1405 can also be used for storing temporary variables or other intermediate information during execution of instructions by the processor 1403. The computer system 1400 may further include a read only memory (ROM) 1407 or other static storage device coupled to the bus 1401 for storing static information and instructions for the processor 1403. A storage device 1409, such as a magnetic disk or optical disk, is coupled to the bus 1401 for persistently storing information and instructions.

The computer system 1400 may be coupled via the bus 1401 to a display 1411, such as a cathode ray tube (CRT), liquid crystal display, active matrix display, or plasma display, for displaying information to a computer user. An input device 1413, such as a keyboard including alphanumeric and other keys, is coupled to the bus 1401 for communicating information and command selections to the processor 1403. Another type of user input device is a cursor control 1415, such as a mouse, a trackball, or cursor direction keys, for communicating direction information and command selections to the processor 1403 and for controlling cursor movement on the display 1411.

According to an exemplary embodiment, the processes described herein are performed by the computer system 1400, in response to the processor 1403 executing an arrangement of instructions contained in main memory 1405. Such instructions can be read into main memory 1405 from another computer-readable medium, such as the storage device 1409. Execution of the arrangement of instructions contained in main memory 1405 causes the processor 1403 to perform the process steps described herein. One or more processors in a multi-processing arrangement may also be employed to execute the instructions contained in main memory 1405. In alternative embodiments, hard-wired circuitry may be used in place of or in combination with software instructions to implement exemplary embodiments. Thus, exemplary embodiments are not limited to any specific combination of hardware circuitry and software.

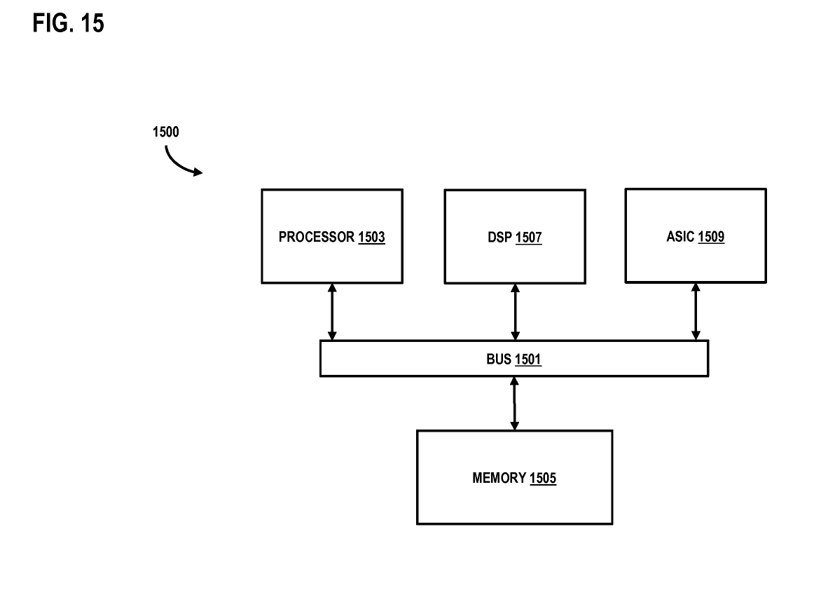

The computer system 1400 also includes a communication interface 1417 coupled to bus 1401. The communication interface 1417 provides a two-way data communication coupling to a network link 1419 connected to a local network 1421. For example, the communication interface 1417 may be a digital subscriber line (DSL) card or modem, an integrated services digital network (ISDN) card, a cable modem, a telephone modem, or any other communication interface to provide a data communication connection to a corresponding type of communication line. As another example, communication interface 1417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1417 sends and receives electrical, electromagnetic, or optical signals that carry digital data streams representing various types of information. Further, the communication interface 1417 can include peripheral interface devices, such as a Universal Serial Bus (USB) interface, a PCMCIA (Personal Computer Memory Card International Association) interface, etc. Although a single communication interface 1417 is depicted in FIG. 15, multiple communication interfaces can also be employed.

The network link 1419 typically provides data communication through one or more networks to other data devices. For example, the network link 1419 may provide a connection through local network 1421 to a host computer 1423, which has connectivity to a network 1425 (e.g. a wide area network (WAN) or the global packet data communication network now commonly referred to as the “Internet”) or to data equipment operated by a service provider. The local network 1421 and the network 1425 both use electrical, electromagnetic, or optical signals to convey information and instructions. The signals through the various networks and the signals on the network link 1419 and through the communication interface 1417, which communicate digital data with the computer system 1400, are exemplary forms of carrier waves bearing the information and instructions.

The computer system 1400 can send messages and receive data, including program code, through the network(s), the network link 1419, and the communication interface 1417. In the Internet example, a server (not shown) might transmit requested code belonging to an application program for implementing an exemplary embodiment through the network 1425, the local network 1421 and the communication interface 1417. The processor 1403 may execute the transmitted code while being received and/or store the code in the storage device 1409, or other non-volatile storage for later execution. In this manner, the computer system 1400 may obtain application code in the form of a carrier wave.

The term “computer-readable medium” as used herein refers to any medium that participates in providing instructions to the processor 1403 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1409. Volatile media include dynamic memory, such as main memory 1405. Transmission media include coaxial cables, copper wire and fiber optics, including the wires that comprise the bus 1501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 15 illustrates a chip set 1500 upon which an embodiment of the invention may be implemented. Chip set 1500 is programmed to present a slideshow as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1500, or a portion thereof, constitutes a means for performing one or more steps of FIGS. 1B, 4, 7, 8, 11, and 13.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to presenting a slideshow via a set-top box. The memory 1505 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
selecting a representative process of a workflow;
executing with one or more processors the representative process on a source business process management platform including the one or more processors and a target business process management platform including the one or more processors;
capturing a first set of one or more metric values from the source platform in the execution of the representative process and storing in one or more storage devices;
capturing a second set of one or more metric values from the target platform in the execution of the representative process and storing in the one or more storage devices;
generating with the one or more processors an assessment score based on the first set of metric values and the second set of metric values; and
determining whether to migrate from the source platform to the target platform based on the assessment score.

2. A method according to claim 1, wherein the representative process includes a plurality of subprocesses, the method further comprising:
assigning a plurality of weighting values to the subprocesses according to a prioritization scheme,
wherein the assessment score is generated according to the weighting values.

3. A method according to claim 2, wherein the first set of metric values and the second set of metric values relate to execution time of the representative process.

4. A method according to claim 3, further comprising:
identifying one or more execution points in program code of the representative process, wherein the execution points are subject to program calls; and
tagging the points in the program code to log the execution time values.

5. A method according to claim 1, further comprising:
converting program code for the representative process utilized in the source platform into program code compatible with the target platform.

6. A method according to claim 1, further comprising:
specifying, via a graphical user interface, a group of program modules of the source platform;
mapping the group of program modules and variable names to a corresponding group of program modules and variable names of the target platform; and
generating a converted version of the group of program modules and variable names based on the mapping.

7. A method according to claim 6, further comprising:
indicating location of placement of the converted version of the group of program modules and variable names.

8. An apparatus comprising:
at least one processor; and
at least one memory including computer program code for one or more programs,
the at least one memory and the computer program code configured to, with the at least one processor, cause the apparatus to perform at least the following,
select a representative process of a workflow;
execute the representative process on a source business process management platform and a target business process management platform;
capturing a first set of one or more metric values from the source platform in the execution of the representative process;
capture a second set of one or more metric values from the target platform in the execution of the representative process;
generate an assessment score based on the first set of metric values and the second set of metric values; and
determine whether to migrate from the source platform to the target platform based on the assessment score.

9. An apparatus according to claim 8, wherein the representative process includes a plurality of subprocesses, the apparatus being further caused to:
assign a plurality of weighting values to the subprocesses according to a prioritization scheme,
wherein the assessment score is generated according to the weighting values.

10. An apparatus according to claim 9, wherein the first set of metric values and the second set of metric values relate to execution time of the representative process.

11. An apparatus according to claim 10, wherein the apparatus is further caused to:
identify one or more execution points in program code of the representative process, wherein the execution points are subject to program calls; and
tag the points in the program code to log the execution time values.

12. An apparatus according to claim 8, wherein the apparatus is further caused to:
convert program code for the representative process utilized in the source platform into program code compatible with the target platform.

13. An apparatus according to claim 8, wherein the apparatus is further caused to:
specify, via a graphical user interface, a group of program modules of the source platform;
map the group of program modules and variable names to a corresponding group of program modules and variable names of the target platform; and
generate a converted version of the group of program modules and variable names based on the mapping.

14. An apparatus according to claim 13, wherein the apparatus is further caused to:
indicate location of placement of the converted version of the group of program modules and variable names.

15. A non-transitory computer-readable medium including one or more sequences of one or more instructions which, when executed by one or more processors, cause an apparatus to at least perform the steps of:
selecting a representative process of a workflow;
executing the representative process on a source business process management platform and a target business process management platform;
capturing a first set of one or more metric values from the source platform in the execution of the representative process;
capturing a second set of one or more metric values from the target platform in the execution of the representative process;
generating an assessment score based on the first set of metric values and the second set of metric values; and
determining whether to migrate from the source platform to the target platform based on the assessment score.

16. A non-transitory computer-readable medium according to claim 15, wherein the representative process includes a plurality of subprocesses, the apparatus being further caused to perform the step of:
assigning a plurality of weighting values to the subprocesses according to a prioritization scheme,
wherein the assessment score is generated according to the weighting values.

17. A non-transitory computer-readable medium according to claim 16, wherein the first set of metric values and the second set of metric values relate to execution time of the representative process.

18. A non-transitory computer-readable medium according to claim 17, wherein the apparatus is further caused to perform the steps of:
identifying one or more execution points in program code of the representative process, wherein the execution points are subject to program calls; and
tagging the points in the program code to log the execution time values.

19. A non-transitory computer-readable medium according to claim 15, wherein the apparatus is further caused to perform the step of:
converting program code for the representative process utilized in the source platform into program code compatible with the target platform.

20. A non-transitory computer-readable medium according to claim 15, wherein the apparatus is further caused to perform the steps of:
specifying, via a graphical user interface, a group of program modules of the source platform;
mapping the group of program modules and variable names to a corresponding group of program modules and variable names of the target platform; and
generating a converted version of the group of program modules and variable names based on the mapping.

21. A non-transitory computer-readable medium according to claim 20, wherein the apparatus is further caused to perform the step of:
indicating location of placement of the converted version of the group of program modules and variable names.
